(19) United States
(12) Patent Application Publication
(10) Pub. No.: US 2004/0244461 A1
(43) Pub. Date: Dec. 9, 2004

(54) Method for compensating the measurement deviation of an air-flow sensor

(76) Inventors: Thomas Lenzing, Benningen (DE); Uwe Konzelmann, Asperg (DE)

Correspondence Address: Striker Striker & Stenby, 103 East Neck Road, Huntington, NY, 11743, US

(21) Appl. No.: 10/483,311

(22) PCT Filed: Jul. 5, 2002
(86) PCT No.: PCT/DE02/02464

(30) Foreign Application Priority Data
Jul. 11, 2001 (DE) 101 33 526.1

(51) Int. Cl. G01F 25/00

(52) U.S. Cl. 73/1.34; 73/1.27; 702/100

(57) ABSTRACT

The invention relates to a method for compensating for the measurement deviation of an air flow rate sensor, which is disposed in a flow conduit, on the basis of soiling or aging. To compensate for the measurement error, it is proposed that the sensor be acted upon by an air surge and that the response time of the sensor be evaluated. The sensor error caused by the deposit of soil or by aging is finally corrected as a function of the response time.

The invention relates to a method for compensating for the measurement deviation of an air flow rate sensor, as generically defined by the preamble to claim 1.

Air flow rate sensors serve to ascertain the flow rate of air in flow conduits and are used in the automotive industry, for instance, to make it possible to regulate the metering in of combustion air and establish an optimal air/fuel ratio.

For example, air flow rate sensors include a measuring resistor, which is heated by a heating resistor and held at a certain temperature or at a certain resistance. In the operating state, the measuring resistor has an overtemperature that is far above the temperature of the medium. If the flow through the flow conduit subsequently changes, then because of the changed convective heat transfer the temperature of the measuring resistor also changes, thereby mistuning a resistor measurement bridge. As a consequence, the heating output of the heating resistor changes. The heating output of the heating resistor and the voltage applied to the heating resistor are a measure for the flow rate of the flowing medium.

In internal combustion engines and especially in relatively large Diesel engines, depending on the design of the air intake tract of the engine, splashing water (possibly with dissolved salt ingredients), oil and dust can be introduced, and these can contaminate the air flow rate sensor located in the intake tract of the engine. Over the service life of the engine, the resultant dirt deposit on the sensor causes a not inconsiderable characteristic curve drift of the air flow rate sensor, since the convective heat transfer is impaired by the layer of dirt. The consequence is incorrect measurements, which if a maximum allowable tolerance limit is exceeded lead to non-ideal engine operation. Until now, when this tolerance limit was reached, soiled air flow rate sensors had to be replaced.

It is therefore the object of the present invention to create an air flow rate sensor and a method for operating an air flow rate sensor with which a characteristic curve error of the meter can be compensated for.

According to the invention, this object is attained by the characteristics recited in claim 1. Advantageous embodiments of the invention are the subject of dependent claims.

The fundamental inventive concept is to subject the air flow rate sensor to a defined air surge and to evaluate the response time (pulse response). Since the response time is dependent on the thermal storage capacity and thus also on the degree of soiling of the sensor, the error of the air flow rate sensor output signal can be compensated for.

To compensate for the measurement deviation, both the shift in the sensor characteristic curve and the change in the characteristic curve gradient are preferably taken into account.

In the measurement system, calculations for compensating for the measurement deviation are preferably performed; for instance, given flow rate values are assigned new measured values (measured voltages), or a suitable characteristic curve already stored in memory in the system is selected.

To perform the compensation, that is, to adapt the sensor characteristic curve to various degrees of soiling or aging, it is necessary to know the correlation between the response time of air flow rate sensors and the degree of soiling or aging. This correlation results for instance from measurements of the response times of variously severely soiled or aged sensor elements.

The deviation in the sensor characteristic curve of a soiled or aged sensor from that of a new sensor can be ascertained on the basis of laboratory measurements, for instance, and the result can be used to correct the sensor error.

The time which a temperature sensor of the air flow rate sensor requires, after being acted upon by an air surge, to reach a certain temperature is designated in particular as the response time.

Optionally, the response time can also be the time which the output signal of the air flow rate sensor requires in order, after being acted upon by an air surge, to reach a certain percentage of the full measurement signal. Other definitions of the response time are also conceivable.

In addition to evaluating the step response of the sensor, its characteristic curve shift (offset) can also be measured at a certain operating point, preferably in the state of repose, in other words without air being supplied, and used to compensate for the measurement error.

In a preferred feature of the invention, the response times of a plurality of sensors of one air flow rate sensor are ascertained in order to take into account variously thick dirt deposits on the surface of the air flow rate sensor. If the results for the response time deviate sharply from one another, an average value can for instance be calculated.

The correction of the measurement error is preferably done by means of software.

In a preferred feature of the invention, a response time of the air flow rate sensor is ascertained shortly after a motor vehicle engine is shut off. To that end, the engine is run up from a low speed, such as 500 rpm, briefly to a high speed.

From the result of this measurement, a correction calculation for the offset and the intensification of the characteristic curve is then performed, or a characteristic curve already stored in memory in the system is evaluated. The correction is finally taken into account in evaluating the air flow rate sensor output signal after a new startup of the vehicle.

### DETAILED DESCRIPTION OF THE DRAWINGS

The invention is described in further detail as an example below in conjunction with the drawings. Shown are:

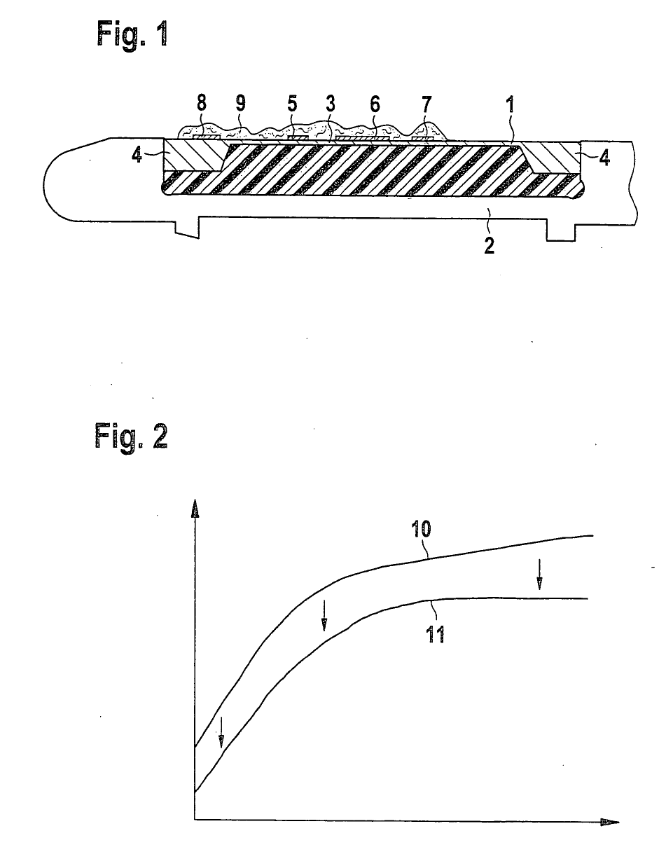

FIG. 1, one exemplary embodiment of an air flow rate sensor;

FIG. 2, the change in the sensor characteristic curve caused by soiling or aging.

FIG. 1 shows one possible realization of an air flow rate sensor 1, which is disposed on a support plate 2. The air flow rate sensor 1 comprises a diaphragmlike heating region 3, on which a plurality of resistors 5, 6, 7 are arranged, and a thicker peripheral region 4.

The resistors 5, 6, 7 are components of a measurement bridge circuit, which in the normal state is tuned. The resistor 6 is a measuring resistor, which is heated by the heating region 3 beneath it and is kept at a certain temperature or at a certain resistance.

In operation, air flows over the surface of the air flow rate sensor 1 and cools the heating region of the sensor as a function of the flow velocity and of the air temperature. If the throughflowing quantity then changes, then because of the altered convective heat transfer, the temperature of the measuring resistor 6 also changes, thus mistuning the measurement bridge circuit. This leads to intensified heating of the measuring resistor 6. The heating output or the voltage applied to the heating element is a measure for the flow rate of the flowing medium.

To ascertain the temperature of the inflowing air, a temperature sensor 8 is provided on the outer peripheral region of the sensor 1.

Reference numeral 9 designates a layer of dirt that has been deposited over the course of operation on the surface of the air flow rate sensor and that engenders a not inconsiderable characteristic curve drift of the air flow rate sensor 1. This dirt layer impairs the convective heat transfer, which can result in incorrect measurements that lead to incorrect engine management.

FIG. 2 shows a starting characteristic curve 10 of an air flow rate sensor 1 in the new state, compared to a characteristic curve 11 of the sensor covered with a layer of dirt.

It can be seen clearly that the dirt deposit on the sensor causes a characteristic curve drift which can lead to incorrect measurements. More precisely, the soiling causes both a characteristic curve shift (offset) and a reduction in the intensification, so that the characteristic curve 11 of the soiled air flow rate sensor is as a rule below that of a new air flow rate sensor.

1. A method for compensating for measurement deviations of an air flow rate sensor disposed in a flow conduit on the basis of soiling or aging, characterized by the following steps:
pulsed imposition of air upon the air flow rate sensor (1);
ascertainment of the response time of the air flow rate sensor (1); and
correction of the measurement deviation as a function of the response time ascertained.

2. The method of claim 1,
characterized in that the correction of the sensor error is effected by calculating corrected characteristic curve values or by selecting a suitable characteristic curve already stored in register.

3. The method of claim 1 or 2,
characterized in that for correcting the sensor error, correction values for the characteristic curve offset and the slope of the characteristic curve are ascertained.

4. The method of claim 3
characterized in that the correction values are stored in memory in the measurement system.

5. The method of one of the foregoing claims,
characterized in that the correlation between an air flow rate sensor output signal and the degree of soiling or aging is ascertained on the basis of laboratory measurements, and the result is used for correcting the measurement deviation.

6. The method of one of the foregoing claims,
characterized in that in the compensation for the measurement error, a null point shift of the sensor characteristic curve is taken into account.

7. The method of claim 6
characterized in that the characteristic curve offset is measured at a defined point on the characteristic curve, in particular in the state of repose.

8. The method of one of the foregoing claims,
characterized in that the response time is the time until a temperature sensor, after being acted upon by air, has reached a certain temperature.

9. The method of one of claims 1-7,
characterized in that the response time is the time until the measurement signal of the sensor, after being acted upon by air, has reached a certain percentage of its full measurement signal.

10. The method of one of the foregoing claims,
characterized in that the compensation for the measurement error is performed by means of software.

11. The method of one of the foregoing claims,
characterized in that the determination of correction values for the compensation for the measurement error is performed upon shutoff of a motor vehicle engine, the engine being briefly run up to high speed after being shut off in order to generate an air surge.
